(19) United States
(12) Patent Application Publication
(10) Pub. No.: US 2008/0046931 A1
(43) Pub. Date: Feb. 21, 2008

(54) Apparatus, system and method for secondary navigation options

(76) Inventors: Kevin Corbett, Rescue, CA (US); Brian David Johnson, Portland, OR (US); David Koste, Tacoma, WA (US)

Correspondence Address: INTEL CORPORATION;c/o INTELLEVATE, LLC, P.O. BOX 52050, MINNEAPOLIS, MN, 55402, US

(21) Appl. No.: 11/496,771

(22) Filed: Jul. 31, 2006

(51) Int. Cl. H04N 5/445

(52) U.S. Cl. 725/52; 725/53

(57) ABSTRACT

An apparatus, system and method that allows for secondary navigation options via a user interface. The method includes displaying a user interface on a display device, where the user interface includes a menu having one or more menu selections. Then, activating one of the one or more menu selections by displaying a sub-menu, where the sub-menu is displayed on the display device as a hover highlight over the menu. Other embodiments are described and claimed.

### BACKGROUND

Television (TV) display user interfaces have design lay outs to receive information from a standard TV remote control. However, navigation and/or manipulation of a today's user interfaces are slow and confusing via a standard TV remote control.

### BRIEF DESCRIPTION OF THE DRAWINGS

FIG. 1 illustrates one embodiment of a user interface.

FIG. 2 illustrates one embodiment of a user interface.

FIG. 3 illustrates one embodiment of a navigation controller.

FIG. 4 illustrates one embodiment of a system.

FIG. 5 illustrates one embodiment of a logic flow.

FIG. 6 illustrates one embodiment of a device.

FIG. 7 illustrates one embodiment of a user interface.

### DETAILED DESCRIPTION

Various embodiments may be generally directed to a user interface that allows for secondary navigation options. In one embodiment, for example, the user interface includes a navigation section that may provide navigation for TV content and/or service browsing. The navigation section initially displays a navigation menu having one or more menu selections. Based on the particular menu selection that is activated, it is determined whether a navigation sub-menu has been defined for the selected menu selection. If so, the navigation menu becomes understated in some fashion while still partly being displayed. In an embodiment of the invention, the navigation menu may be low-lighted or grayed by a percentage. For example, the background of the navigation menu grays 75%. The navigation sub-menu is then displayed partially over the previous navigation menu as a “hover highlight” (i.e., the sub-menu “hovers” over the menu in a highlighted fashion without completely replacing or covering the menu). The highlighted fashion is meant to include any means of making the sub-menu “stand out” over the menu. This may include, but is not necessarily limited to, the background, text, virtual keys, etc, of the sub-menu being more pronounced than those in the menu. The understating of the previous menu (e.g., the navigation menu) and the hover highlighting of the now current menu (e.g., the navigation sub-menu) allows the user to easily recall any previous navigation menus, as well as the current navigation menu. Additionally, the hover highlighting of the current menu over the previous menu allows the user to quickly activate the desired selection. Other embodiments may be described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

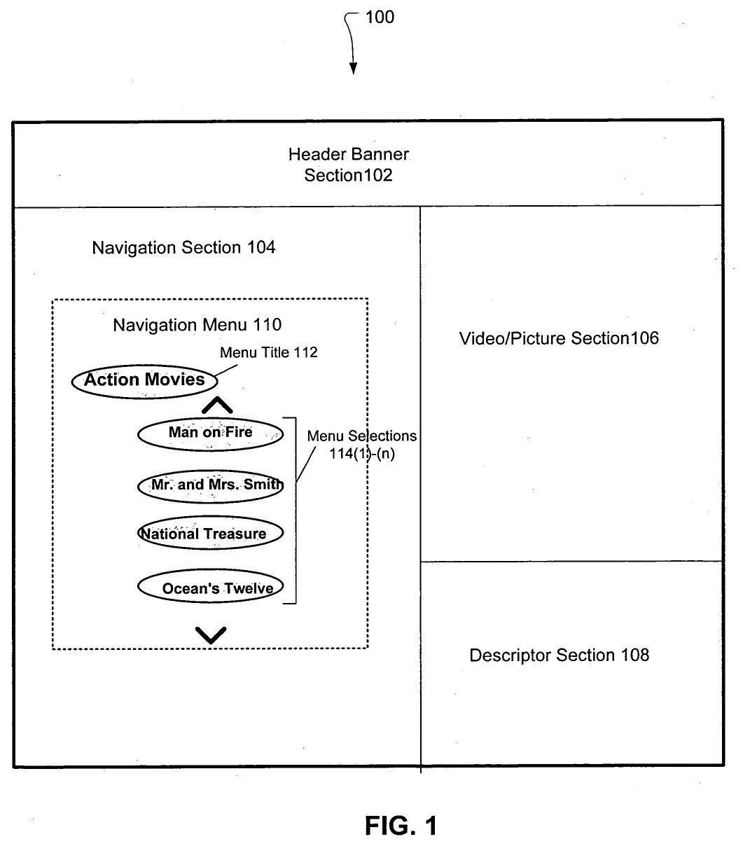

FIG. 1 illustrates one embodiment of a user interface 100. User interface 100 may comprise a header banner section 102, a navigation section 104, a video/picture section 106 and a descriptor section 108. User interface 100 may be displayed on a display device, for example. Each of these sections is described next in more detail.

Header banner section 102 may be used to display a high-level title for user interface 100. Video/Picture section 106 displays content, where the content may include shows or programs, graphics, video games, books, and so forth. Related voice, audio, music, etc., may also be presented with the displayed content in section 106. Descriptor section 108 informs the user of the content provided in video/picture section 106. For example, descriptor section 108 may provide related guide data such as content name, channel or location (e.g., location on the Internet via an Internet Protocol (IP) address or Uniform Resource Location (URL), location on a local hard disk, etc.), type of content (e.g., broadcast, stream, download, etc.), metadata (e.g., content description, year of release, ratings information, category, etc.), air time, a brief synopsis, stars, and so forth. Again, related voice, audio, music, etc., may also be presented with the displayed content in section 108. These examples are not meant to limit the invention.

Navigation section 104 may comprise a navigation menu 110. Navigation menu 110 may provide navigation for TV content and/or service browsing. Navigation menu 110 may comprise virtual keys or buttons that are used to navigate user interface 100. The virtual keys of menu 110 may comprise one or more indicia thereon. The virtual keys may comprise any type of indicia to represent any type of information. The indicia may comprise, for example, graphics, icons, letters, characters, symbols, and/or functions. The indicia also may be user defined, for example. In one embodiment, the indicia may comprise characters and/or symbols similar to the characters and/or symbols found in conventional keyboards. The various embodiments described herein, however, are not limited in the context of the embodiment illustrated in FIG. 1 as the indicia on the virtual keys may represent any predefined character, symbol, modifier, control, alternative, function, or shift keys.

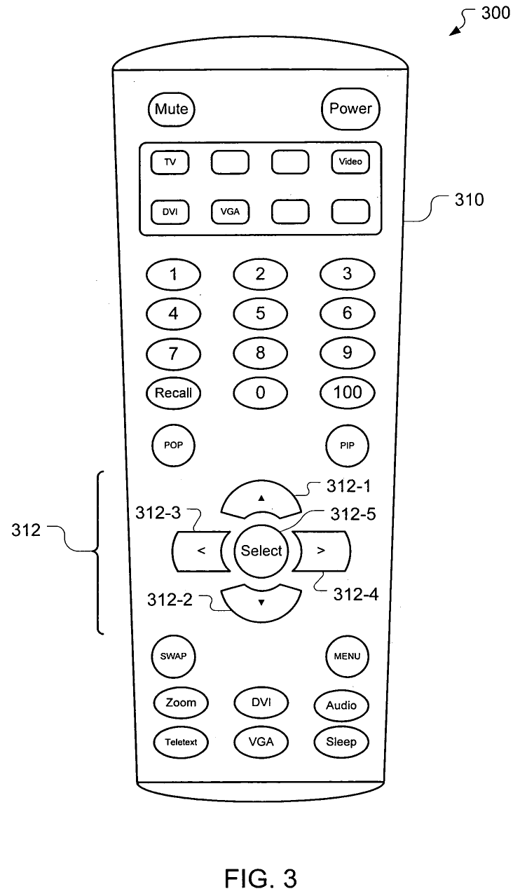

The virtual keys of navigation section 104 may be activated by a user via navigation controller. In one embodiment, the navigation controller may be a pointing device or remote control, as will be described below with reference to FIG. 3.

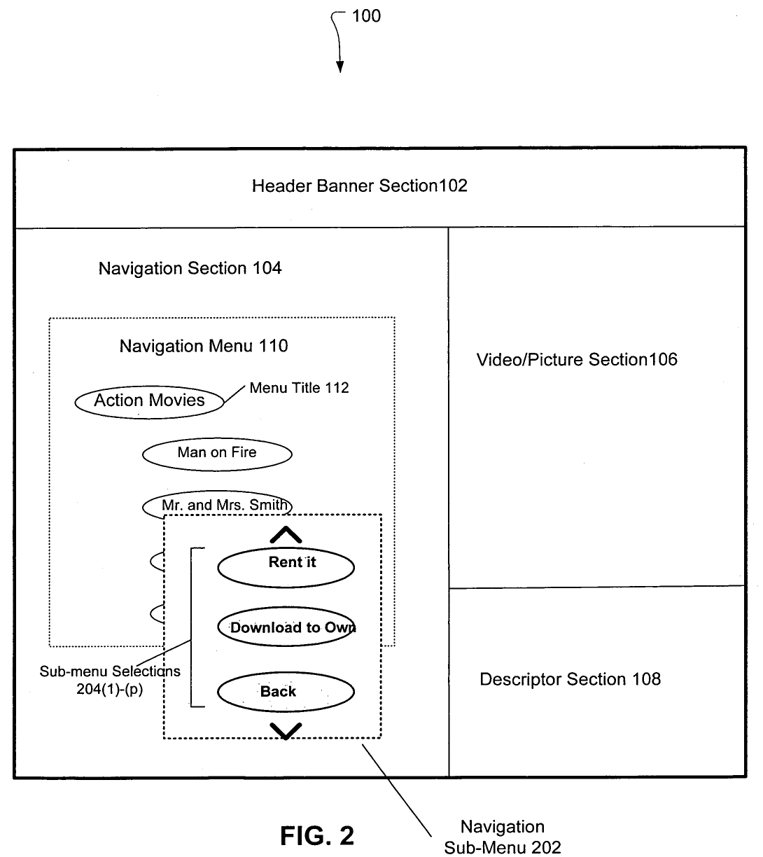

Referring again to FIG. 1, navigation menu 110 may comprise a menu title 112 and one or more menu selections 114(1)-(n), where n is any positive integer. Menu selections 114(1)-(n) may be expandable. In the example user interface of FIG. 1, the menu title 112 is “Action Movies” and menu selections 114(1)-(n) or action movie selections include “Man on Fire”, “Mr. and Mrs. Smith”, “National Treasure” and “Ocean's Twelve”. One or more of menu selections 114(1)-(n) may be activated to present a secondary sub-menu of further selections related to the activated menu selection. Accordingly, the secondary sub-menu may provide secondary navigation for TV content and/or service browsing. In an embodiment of the invention, the menu and sub-menu selections are fed to user interface 100 via dynamic feed (e.g., metadata). An embodiment of the secondary sub-menu is illustrated in FIG. 2.

As illustrated in FIG. 2, menu selection or action movie “Mr. and Mrs. Smith” was activated. In an embodiment of the invention, when one of menu selections 114(1)-(n) is activated, navigation menu 110 becomes understated in some fashion while still partly being displayed. In an embodiment of the invention, navigation menu 110 may be low-lighted or grayed by a percentage. For example, the background of navigation menu 110 grays 75%. These example embodiments are provided for illustration purposes only and are not meant to limit the invention.

Based on the particular menu selection that is activated, it is determined whether a navigation sub-menu has been defined for the selected menu selection. If so, the navigation sub-menu, such as a navigation sub-menu 202, is displayed partially over navigation menu 110 as a “hover highlight” (i.e., sub-menu 202 “hovers” over menu 110 in a highlighted fashion without completely replacing or covering menu 110). The highlighted fashion is meant to include any means of making sub-menu 202 “stand out” over menu 110. This may include, but is not necessarily limited to, the background, text, virtual keys, etc, of sub-menu 202 being more pronounced than those in menu 110. The understating of the previous menu (e.g., navigation menu 110) and the hover highlighting of the now current menu (e.g., navigation sub-menu 202) allows the user to easily recall any previous navigation menus, as well as the current navigation menu. Additionally, the hover highlighting of the current menu over the previous menu allows the user to quickly activate the desired selection.

As illustrated in FIG. 2, the activation of menu selection “Mr. and Mrs. Smith” results in the display of navigation sub-menu 202 with three sub-menu selections 204(1)-(p), where p is a positive integer. Sub-menu selections 204(1)-(p) may be expandable. These selections illustrated in FIG. 2 include “Rent it”, “Download to Own” and “Back”. In general, the activation of a menu selection may also cause any other type of information to be displayed including, but not limited to, a text entry box, a message, and so forth. Additionally, each of the menu and sub-menu selections may represent any variable information. This selection information may be dynamic, adjustable and considered to be independent from any of the previous menus and/or menu selections. For example, pricing of a menu or sub-menu selection may be dynamic, adjustable and independent from any other menu or sub-menu selection. In other words, pricing of a selection may be changed without affecting any other menu or sub-menu. The pricing of a menu or sub-menu selection is provided for illustration purposes only and is not meant to limit the invention. In fact, the dynamic, adjustable and independent nature of the invention applies to all information represented by the menu or sub-menu selections, such as for example, the ability to be displayed in different/multiple languages.

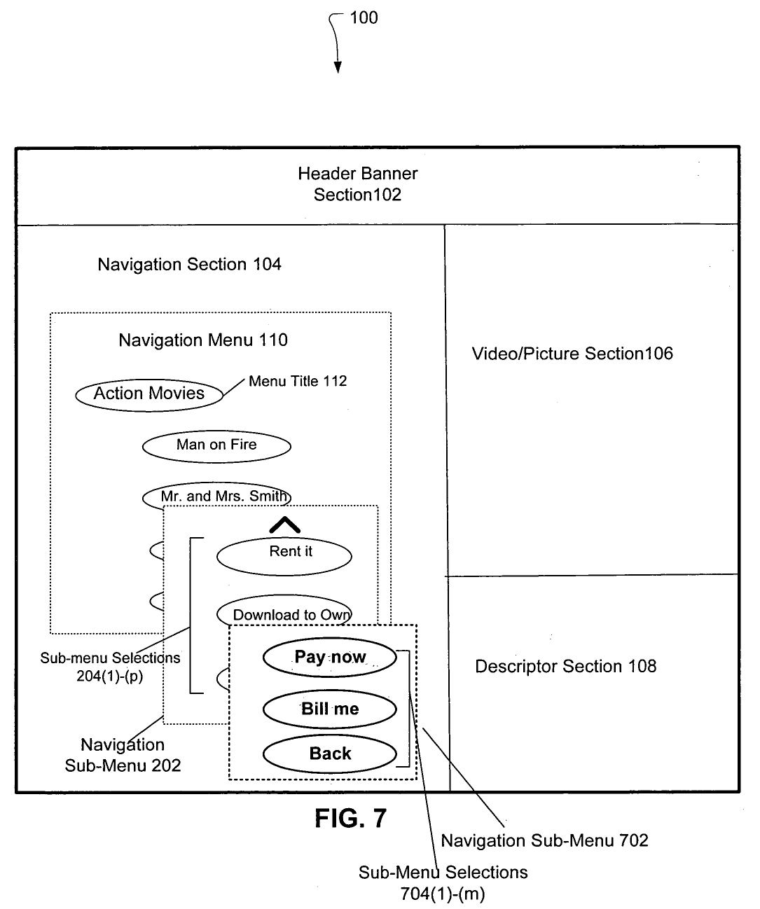

Referring again to FIG. 2, one or more of sub-menu selections (1)-(p), when activated, may cause a further navigation sub-menu to be displayed, a text entry box, a message, or any other type of information. For example, as illustrated in FIG. 7, sub-menu selection “Download to Own” was selected. This selection causes navigation sub-menu 202 to become understated in some manner. Navigation sub-menu 702 is displayed over sub-menu 202 as a hover highlight. Sub-menu 702 includes three sub-menu selections 704(1)-(m), where m is a positive integer. These selections include “Pay now”, “Bill me” and “Back”. For example, if the selection “Pay now” is activated, sub-menu 702 will be understated and a text entry box for entering credit card information may be displayed over sub-menu 702 as a hover highlight. The present invention is not limited to the number of selections for each menu/sub-menu and/or the number of sub-menus that may be defined and displayed. The example menu and sub-menus described with reference to FIGS. 1, 2 and 7 are provided for illustration purposes only and are not meant to limit the invention.

FIG. 3 illustrates one embodiment of a navigation controller 300. In one embodiment, navigation controller 300 may be a pointing device 310 that may be used to activate one or more keys of navigation section 104 (FIG. 1). Pointing device 310 may be any computer hardware component (specifically human interface device) that allows a user to input spatial (i.e., continuous and multi-dimensional) data into a computer. Many systems such as computer aided design (CAD), graphical user interfaces (GUI), and televisions and monitors allow the user to control and provide data to the computer or television using physical gestures—point, click, and drag—typically by moving wired or wireless pointing device such as a mouse, trackball, touchpad, pointing stick, light pen, joystick, head pointer, eye tracking device, digitizing tablet, data glove, remote controller, among others. Movements of pointing device 310 are echoed on a display device by movements of a pointer, cursor, focus ring, or other visual indicators displayed on the display device.

In the illustrated embodiment, pointing device 310 is a conventional remote control unit used to interact with audio/visual devices such as televisions, monitors, cable boxes, digital video disc (DVD) player, compact disc (CD) players, digital video recorders (DVR), video games, digital video camera, and/or digital still camera, among others, for example. Pointing device 310 comprises navigation buttons 312. In one embodiment, the navigation buttons 312 comprise an upward navigation button 312-1, a downward navigation button 312-2, a leftward navigation button 312-3, and a rightward navigation button 312-4. Navigation buttons 312 also may comprise a select button 312-5 to execute a particular function. Pointing device 310 may be a wireless remote that operates on wireless principles employing infra-red (IR) energy or radio frequency (RF) energy. In other embodiments, pointing device 310 may be hard wired to the display device, for example. The embodiments, however, are not limited to the elements or in the context shown or described in FIG. 3.

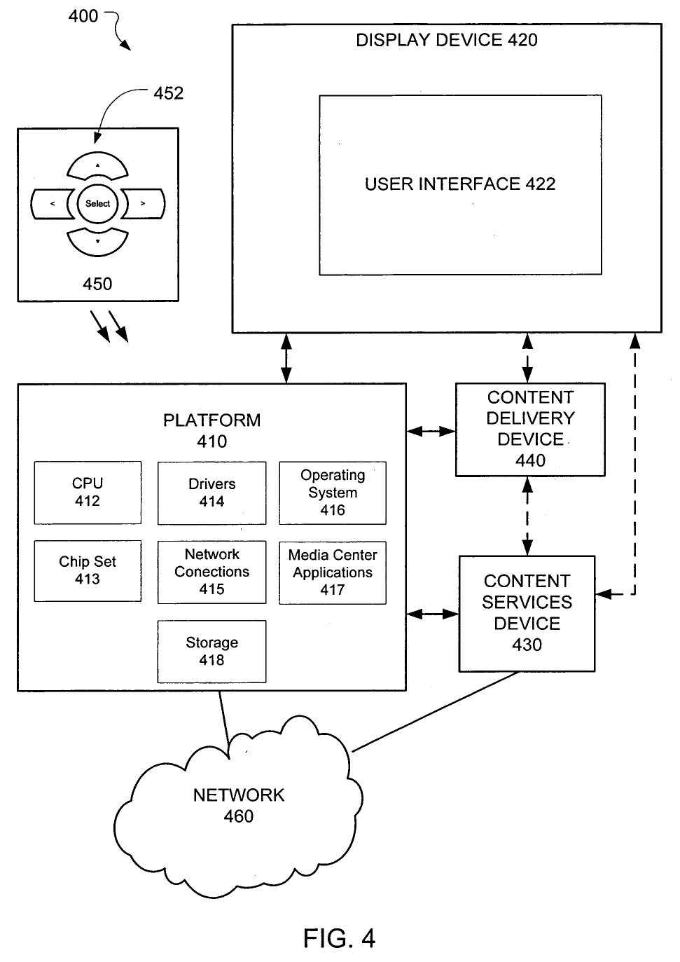

FIG. 4 illustrates one embodiment of a system 400. In one embodiment, system 400 may be a digital home entertainment system although system 400 is not limited in this context. In one embodiment, system 400 comprises a platform 410 coupled to a display device 420. In one embodiment, platform 410 may comprise or may be implemented as a media platform such as the Viiv™ media platform made by Intel® Corporation. In one embodiment, platform 410 may receive content from a content device such as a content services device 430 or a content delivery device 440 or other similar content source. In an embodiment of the invention, content services device 430 may be hosted by any national, international and/or independent service and thus accessible to platform 410 via the Internet. A content services device 430 may be coupled to platform 410 and/or to display device 420. Platform 410 and/or content services device 430 may be coupled to a network 460 to communicate (e.g., send and/or receive) media information to and from network 460. A content delivery device 440 also may be coupled to platform 410 and/or to display device 420. In various embodiments, platform 410 and content services device 430 may be integrated, or platform 410 and content delivery device 440 may integrated, or platform 410, content services device 430, and content delivery device 440 may be integrated, for example. In various embodiments, platform 410 and display device 420 may be an integrated unit and display device, or content service device 430 may be integrated, or display device 420 and content delivery device 440 may integrated. A navigation controller 450 comprising one or more navigation buttons 452 may be used to interact with either platform 410 or display device 420, and/or both, for example.

In one embodiment, platform 410 may comprise a CPU 412, a chip set 413, one or more drivers 414, one or more network connections 415, an operating system 416, and/or a media center application 417 comprising one or more software applications, for example. Platform 410 also may comprise storage 418. Storage 418 may include control and content data used to define one or more navigation menus (e.g., navigation menu 110 of FIG. 1), one or more navigation sub-menus (such as sub-menu 202 of FIG. 2), one or more text entry boxes, messages, and so forth. In an embodiment of the invention, the menu and sub-menu selections are fed to user interface 100 via dynamic feed (e.g., metadata stored in storage 418). Storage 418 may also include the control and content data displayed in video/picture section 106 and descriptor section 108, as described above in FIG. 1.

In one embodiment, CPU 412 may comprise one or more processors such as dual-core processors. Examples of dual-core processors include the Pentium® D processor and the Pentium® processor Extreme Edition both made by Intel® Corporation, which may be referred to as the Intel Core Duo processors, for example.

In one embodiment, chip set 413 may comprise any one of or all of the Intel® 945 Express Chipset family, the Intel® 955X Express Chipset, Intel® 975X Express Chipset family, plus ICH7-DH or ICH7-MDH controller hubs, which all are made by Intel® Corporation.

In one embodiment, drivers 414 may comprise the Quick Resume Technology Drivers made by Intel® to enable users to instantly turn on and off platform 410 like a television with the touch of a button after initial boot-up, when enabled, for example. In addition, chip set 413 may comprise hardware and/or software support for 5.1 surround sound audio and/or high definition 7.1 surround sound audio, for example. Drivers 414 may include a graphics driver for integrated graphics platforms. In one embodiment, the graphics driver may comprise a peripheral component interconnect (PCI) Express graphics card.

In one embodiment, network connections 415 may comprise the PRO/1000 PM or PRO/100 VE/VM network connection, both made by Intel® Corporation.

In one embodiment, operating system 416 may comprise the Windows® XP Media Center made by Microsoft® Corporation. In one embodiment, one or more media center applications 417 may comprise a media shell to enable users to interact with content using navigation controller 450 (e.g., remote control) from a distance of about 10-feet away from platform 410 or display device 420, for example. In one embodiment, the media shell may be referred to as a “10-feet user interface,” for example. In addition, one or more media center applications 417 may comprise the Quick Resume Technology made by Intel®, which allows instant on/off functionality and may allow platform 410 to stream content to media adaptors or other content services devices 430 or content delivery devices 440 when the platform is turned “off.”

In one embodiment, storage 418 may comprise the Matrix Storage technology made by Intel® to increase the storage performance enhanced protection for valuable digital media when multiple hard drives are included, for example.

In one embodiment, display device 420 may comprise any television type monitor or display. Display device 420 may comprise, for example, a computer display screen, video monitor, television-like device, and/or a television. Display device 420 may be digital and/or analog.

In various embodiments, content services device 430 may comprise a cable television box, personal computer, network, telephone, Internet enabled devices or appliance capable of delivering digital information and/or content, and any other similar device capable of unidirectionally or bidirectionally communicating content between content providers and platform 410 and/display device 420, via network 460. It will be appreciated that the content may be communicated unidirectionally and/or bidirectionally to and from any one of the components in system 400 and a content provider via network 460. Examples of content may include any media information including, for example, video, music, and gaming information. Content services device 430 receives content such as cable television programming including media information, digital information, and/or other content. Examples of content providers may include any cable or satellite television or radio content providers and may include, for example, ESPN, Movielink, and MTV Overdrive for video; Napster, AOL and Tiscali for music; Gametap, Square Enix and T-Online for gaming; and YouTube and Flickr for sharing services.

In various embodiments, content delivery device 440 may comprise a DVD player, CD player, DVR, video game, digital video camera, digital still camera, and/or MP3 (MPEG-1 Audio Layer 3 where MPEG stands for Moving Pictures Experts Group) player, among others, for example.

Platform 410 may receive content from network 460 directly or via content services device 430. Platform 410 may receive content from content delivery device 440. Under the control of one or more software applications, such as media center application 417, platform 410 displays user interface 422 (e.g., user interface 100) on display device 420.

In one embodiment, platform 410 may receive control signals from navigation controller 450 (e.g., navigation controller 300 of FIG. 3). Navigation buttons 452 (e.g., navigation buttons 312 of FIG. 3) may be used to interact with user interface 422. For example, under the control of software applications, e.g., media center applications 417, navigation buttons 452 located on navigation controller 450 may be mapped to the virtual navigation keys of navigation section 104 (FIGS. 1 and 2).

In various embodiments, system 400 may be implemented as a wireless system, a wired system, or a combination of both. When implemented as a wireless system, system 400 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 400 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 410 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 4.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof.

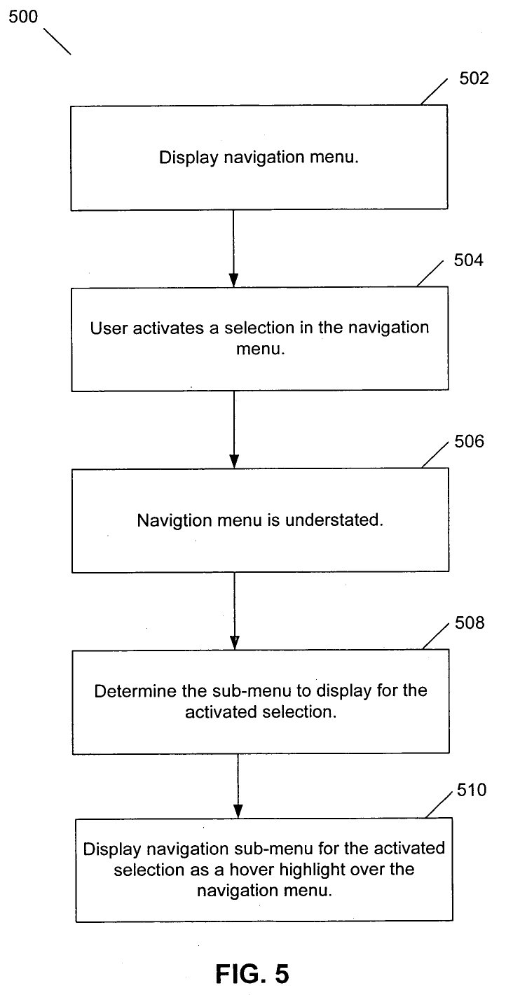

FIG. 5 illustrates one embodiment of a logic flow 500. The logic flow 500 may be representative of the operations executed by one or more embodiments described herein, for example, the operations executed by system 400. In one embodiment, logic flow 500 may be representative of the operations executed by a processor (e.g., the CPU 412) under the control of one more software applications (e.g., media center applications 417). Platform 410 comprising processor 412 provides the necessary information to display device 420 to map user interface 422 on display device 420.

As shown in logic flow 500, a navigation menu is displayed (such as navigation menu 110 of FIG. 1), at block 502. The navigation menu includes one or more menu selections. In an embodiment of the invention, the menu selections are fed to the navigation menu via dynamic feed (e.g., metadata).

A user may activate or select one of the menu selections via a pointing device or remote control (such as pointing device 310 of FIG. 3), at block 504. The activation of a menu selection causes the displayed navigation menu to become understated in some fashion but still be partially visible to the user, at block 506. As discussed above, the background of the navigation menu may be low-lighted or grayed by a percentage.

At block 508, the navigation sub-menu to display for the activated selection is determined. The determined navigation sub-menu is displayed as a hover highlight over the navigation menu, at block 510. The embodiments, however, are not limited to the elements or in the context shown or described in FIG. 5.

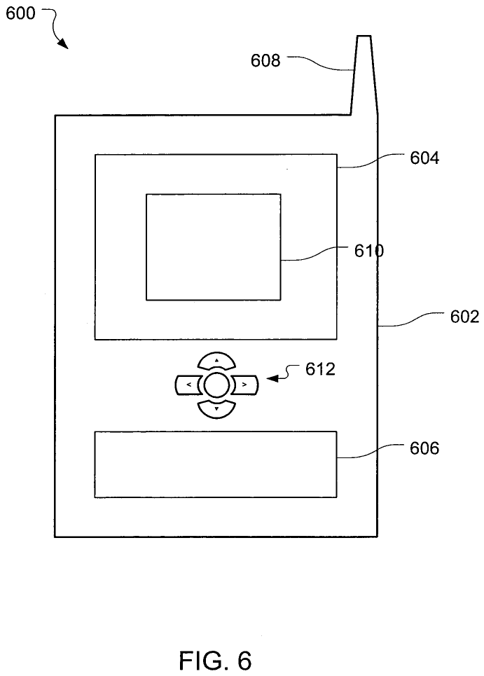

FIG. 6 illustrates one embodiment of a device 600. In one embodiment, for example, device 600 may comprise a communication system. In various embodiments, device 600 may comprise a processing system, computing system, mobile computing system, mobile computing device, mobile wireless device, computer, computer platform, computer system, computer sub-system, server, workstation, terminal, personal computer (PC), laptop computer, ultra-laptop computer, portable computer, handheld computer, personal digital assistant (PDA), cellular telephone, combination cellular telephone/PDA, smart phone, pager, one-way pager, two-way pager, messaging device, and so forth. The embodiments are not limited in this context.

In one embodiment, device 600 may be implemented as part of a wired communication system, a wireless communication system, or a combination of both. In one embodiment, for example, device 600 may be implemented as a mobile computing device having wireless capabilities. A mobile computing device may refer to any device having a processing system and a mobile power source or supply, such as one or more batteries, for example. Examples of a mobile computing device may include a laptop computer, ultra-laptop computer, portable computer, handheld computer, palmtop computer, personal digital assistant (PDA), cellular telephone, combination cellular telephone/PDA, smart phone, pager, one-way pager, two-way pager, messaging device, data communication device, and so forth. Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In one embodiment, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 6, device 600 may comprise a housing 602, a display 604, an input/output (I/O) device 606, and an antenna 608. Device 600 also may comprise a five-way navigation button 612. I/O device 606 may comprise a suitable keyboard, a microphone, and/or a speaker, for example. Display 604 may comprise any suitable display unit for displaying information appropriate for a mobile computing device. I/O device 606 may comprise any suitable I/O device for entering information into a mobile computing device. Examples for I/O device 606 may include an alphanumeric keyboard, a numeric keypad, a touch pad, input keys, buttons, switches, rocker switches, voice recognition device and software, and so forth. Information also may be entered into device 600 by way of microphone. Such information may be digitized by a voice recognition device. The embodiments are not limited in this context.

Device 600 may comprise a user interface 610 that may be displayed on display 604 similar to user interface 100 discussed herein.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a processor to receive a control signal from a navigation controller and to display a user interface on a display device, wherein the user interface includes a menu having one or more menu selections, and based on the control signal the processor to activate one of the one or more menu selections to display a sub-menu, wherein the sub-menu is displayed on the display device as a hover highlight over the menu.

2. The apparatus of claim 1, wherein the processor comprises logic to understate the display of the menu on the display device once the menu selection is activated.

3. The apparatus of claim 2, wherein the display of the menu is understated by graying a background of the menu by a percentage.

4. The apparatus of claim 3, wherein the percentage is 75 percent.

5. The apparatus of claim 1, wherein the menu is a navigation menu and the sub-menu is a navigation sub-menu.

6. The apparatus of claim 1, wherein the sub-menu includes one or more sub-menu selections and wherein the one or more menu selections and the one or more sub-menu selections are fed to the user interface via dynamic feed.

7. The apparatus of claim 6, wherein the dynamic feed is metadata.

8. The apparatus of claim 6, wherein each of the menu and sub-menu selections are adjustable and independent from any of the other menu and sub-menu selections.

9. The apparatus of claim 1, wherein the navigation controller is a remote control device.

10. A system, comprising:
a content device; and
a processor coupled to the content device, the processor to receive a control signal from a navigation controller and to display a user interface on a display device, wherein the user interface includes a menu having one or more menu selections, and based on the control signal the processor to activate one of the one or more menu selections to display a sub-menu, wherein the sub-menu is displayed on the display device as a hover highlight over the menu.

11. The system of claim 10, wherein the processor to understate the display of the menu on the display device once the menu selection is activated.

12. The system of claim 11, wherein the display of the menu is understated by graying a background of the menu by a percentage.

13. The system of claim 10, wherein the sub-menu includes one or more sub-menu selections and wherein the one or more menu selections and the one or more sub-menu selections are fed to the user interface via dynamic feed.

14. The system of claim 13, wherein the dynamic feed is metadata.

15. The system of claim 13, wherein each of the menu and sub-menu selections are adjustable and independent from any of the other menu and sub-menu selections.

16. A method, comprising:
displaying a user interface on a display device, wherein the user interface includes a menu having one or more menu selections; and
activating one of the one or more menu selections to display a sub-menu, wherein the sub-menu is displayed on the display device as a hover highlight over the menu.

17. The method of claim 16, further comprising:
understating the display of the menu on the display device once the menu selection is activated.

18. The method of claim 17, wherein the display of the menu is understated by graying a background of the menu by a percentage.

19. The method of claim 16, wherein the menu is a navigation menu and the sub-menu is a navigation sub-menu.

20. The method of claim 16, wherein the sub-menu includes one or more sub-menu selections and wherein the one or more menu selections and the one or more sub-menu selections are fed to the user interface via dynamic feed.

21. The method of claim 20, wherein the dynamic feed is metadata.

22. The method of claim 20, wherein each of the menu and sub-menu selections are adjustable and independent from any of the other menu and sub-menu selections.

23. A machine-readable medium containing instructions which, when executed by a processing system, cause the processing system to perform a method, the method comprising:
displaying a user interface on a display device, wherein the user interface includes a menu having one or more menu selections; and
activating one of the one or more menu selections to display a sub-menu, wherein the sub-menu is displayed on the display device as a hover highlight over the menu.

24. The machine-readable medium of claim 23, further comprising:
understating the display of the menu on the display device once the menu selection is activated.

25. The machine-readable medium of claim 24, wherein the display of the menu is understated by graying a background of the menu by a percentage.

26. The machine-readable medium of claim 23, wherein the menu is a navigation menu and the sub-menu is a navigation sub-menu.

27. The machine-readable medium of claim 23, wherein the sub-menu includes one or more sub-menu selections and where the one or more menu selections and the one or more sub-menu selections are fed to the user interface via dynamic feed.

28. The machine-readable medium of claim 27, wherein the dynamic feed is metadata.

29. The machine-readable medium of claim 27, wherein each of the menu and sub-menu selections are adjustable and independent from any of the other menu and sub-menu selections.
